(19) United States
(12) Patent Application Publication
(10) Pub. No.: US 2015/0232658 A1
(43) Pub. Date: Aug. 20, 2015

(54) SELF-EXTINGUISHING EPOXY RESIN FOR EPOXY MOLDING COMPOUND, METHOD OF PREPARING THE SAME, AND EPOXY RESIN COMPOSITION FOR EPOXY MOLDING COMPOUND.

(71) Applicant: KUKDO CHEMICAL CO., LTD., Seoul (KR)

(72) Inventors: Si-Chang Lee, Seoul (KR); Kyung-Ho Park, Seoul (KR); Tae-Kyoo Shin, Bucheon-si (KR); Jin-Soo Lee, Seoul (KR); Hyun-Ju Hwang, Anyang-si (KR); Hyun-Yool Woo, Seoul (KR)

(73) Assignee: KUKDO CHEMICAL CO., LTD., Seoul (KR)

(21) Appl. No.: 13/996,167

(22) PCT Filed: Apr. 22, 2013
(86) PCT No.: PCT/KR2013/003403

§ 371 Date: Jun. 20, 2013

(30) Foreign Application Priority Data
Apr. 25, 2012 (KR) 10-2012-0043297

(51) Int. Cl. C08L 63/04; C08G 65/48

(52) U.S. Cl. CPC C08L 63/04; C08G 65/48; C08L 2201/02; C08L 2205/025

(57) ABSTRACT

A self-extinguishing epoxy resin for an epoxy molding compound (EMC) represented by Formula 1 is disclosed. The epoxy resin (composition) has excellent flame retardancy without using a halogen flame retardant or a phosphorous flame retardant. Upon comparison with NC-3000 that is one of the most widely and commercially available products of Nippon Kayaku Co., Ltd., the epoxy resin composition is a self-extinguishing epoxy resin for a high-end EMC having better or similar flame retardancy, excellent dimensional stability due to lower shrinkage rate, and ideal physical property balance with lower flexural modulus and higher glass transition temperature.

### BACKGROUND OF THE INVENTION

1. Field of the Invention

The present invention relates to a self-extinguishing epoxy resin for an epoxy molding compound, a method of preparing the same, and an epoxy resin composition for an epoxy molding compound, and, more specifically, to an eco-friendly self-extinguishing epoxy resin for a high-end epoxy molding compound (EMC) that has self-extinguishing properties without using a brominated flame retardant, a phosphorous flame retardant, or the like, a method of preparing the same, and an epoxy resin composition for an epoxy molding compound (EMC).

2. Description of the Related Art

An epoxy molding compound (EMC) is a composite material that includes about 10 raw materials such as silica, an epoxy resin, a phenol resin, carbon black, and a flame retardant. An EMC is widely used as a semiconductor encapsulant (sealant) that serves as protector for transistors, diodes, microprocessors, and semiconductor memories from heat, moisture, impact, and the like.

Although an EMC constitutes only a relatively small portion of the cost needed to manufacture a semiconductor device, the EMC that is used as protection material for the semiconductor device serves an important role in functions of the semiconductor device. In particular, EMC compounding is regarded as a core technology serving an important role affecting semiconductor quality.

The design of the high-end EMC may be defined as balancing engineering. Since an EMC needs to have contradictory properties such as high glass transition temperature and low flexural modulus, advanced technology is required. In order to effectively attain such contradictory requirements, a high-performance epoxy resin having high physical property balance may be used. That is, the high-performance epoxy resin is a core technology in the development of a high-end EMC.

An epoxy resin according to the present invention may have mechanical properties and reliability better than or similar to NC-3000, which is a biphenyl novolac epoxy resin that is one of the most widely commercially available semiconductor encapsulants manufactured by Nippon Kayaku Co., Ltd.

Meanwhile, Korean Patent No. 946206 discloses a phenol polymer, production method thereof, and use thereof. In this document, a phenol polymer having a novel structure used in semiconductor encapsulants as a hardener is disclosed, and NC-3000 is used an epoxy resin.

### SUMMARY OF THE INVENTION

The present inventors have found that a self-extinguishing epoxy resin for an epoxy molding compound (EMC) having excellent physical properties may be prepared through epoxidation of a conventional phenol polymer disclosed in Korean Patent No. 946206.

Therefore, it is an object of the present invention to provide a self-extinguishing epoxy resin for an epoxy molding compound (EMC) represented by Formula 1 below.

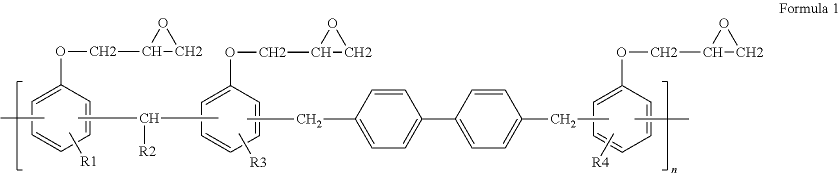

In Formula 1, R1, R3, and R4 are each independently H, CH₃, or an alkyl group,

R2 is a biphenyl group

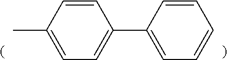

or a benzyl group

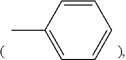

and

n is a natural number of 1 to 100.

It is another object of the present invention to provide an epoxy resin composition for an epoxy molding compound using the resin represented by Formula 1 above.

The epoxy resin (composition) according to the present invention was determined to have excellent flame retardancy without the use of a halogen flame retardant or a phosphorous flame retardant. Upon comparison with NC-3000 that is one of the most widely and commercially available products of Nippon Kayaku Co., Ltd., it has been found that the epoxy resin composition according to the present invention is a self-extinguishing epoxy resin for a high-end EMC that has better or similar flame retardancy, excellent dimensional stability due to lower shrinkage rate, and ideal physical property balance with lower flexural modulus and higher glass transition temperature.

In order to overcome the above problems, the present inventors have found that the epoxy resin represented by Formula 1 may be used to prepare a composition for an EMC. Accordingly, a high end (i.e. high value added) epoxy resin may be prepared, which is eco-friendly, while neither a halogen flame retardant nor a phosphorus flame retardant is used, has excellent self-extinguishing properties, and ideal physical property balance, may be prepared.

The resin represented by Formula 1 below according to the present invention is a high value-added self-extinguishing epoxy resin prepared from a novolac formed through reaction of a phenol, a bismethylbiphenyl compound, and benzaldehyde or through reaction of a phenol, a bismethylbiphenyl compound, and 4-phenyl benzaldehyde, and performing epoxidation of the resultant.

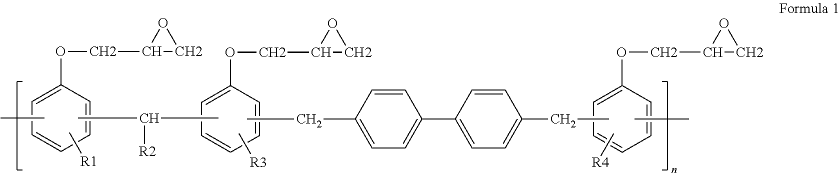

In Formula 1, R1, R3, and R4 are each independently H, CH₃, or an alkyl group,

R2 is a biphenyl group

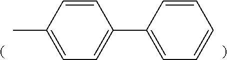

or a benzyl group

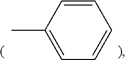

and

n is a natural number of 1 to 100.

### DETAILED DESCRIPTION OF THE INVENTION

An epoxy resin, according to the present invention, may be prepared by using a phenol polymer obtained through reaction of a phenol, a bismethylbiphenyl compound, and an aromatic aldehyde, and a composition of the epoxy resin may be prepared by using the phenol polymer.

More specifically, a phenol, 4,4′-bis(methoxy-methyl biphenyl), and 4-phenylbenzaldehyde or benzaldehyde are reacted to prepare a novolac resin, and epichlorohydrin is reacted with a hydroxyl group of the novolac resin to prepare an epoxy resin.

Hereinafter, examples will be provided for further understanding of the invention. The following examples are for illustrative purposes only and are not intended to limit the scope of the present invention.

### Example 1

### Preparation of Novolac Resin Using 4-Phenylbenzaldehyde

212 g of 4-phenylbenzaldehyde, 550 g of phenol, 242 g of 4,4′-bis(methoxy-methyl biphenyl) (BMMB), and 58 g of purified process water (PPW) were added to a flask equipped with a stirrer and a cooling device, and the mixture was dissolved while raising temperature to 90° C. 1.41 g of p-toluene sulfonic acid monohydrate (PTSA) was added thereto as a catalyst, and the mixture was maintained under the same conditions for 3 hours. The mixture was dehydrated by heating to 115° C., and the phenol was collected by adjusting temperature and pressure to 190° C. and 5 torr. Then, 20 g of PPW was added dropwise thereto to minimize residual phenol. As a result, a resin represented by Formula 2 below and having a softening point of 99° C., a molecular weight of 787, and a viscosity of 390 cps at 150° C. was synthesized (single-stage process).

212 g of 4-phenylbenzaldehyde, 550 g of phenol, and 58 g of purified process water (PPW) were added to a flask equipped with a stirrer and a cooling device, and the mixture was dissolved while raising temperature to 90° C. 1.41 g of p-toluene sulfonic acid monohydrate (PTSA) was added thereto as a catalyst, and the mixture was maintained under the same conditions for 1 hour. Then, 242 g of 4,4′-bis(methoxy-methyl biphenyl) (BMMB), as a second raw material, was added thereto, and the mixture was maintained under the same conditions for 3 hours. The mixture was dehydrated by heating to 115° C., and the phenol was collected by adjusting temperature and pressure to 190° C. and 5 torr. Then, 20 g of PPW was added dropwise thereto to minimize residual phenol. As a result, a resin represented by Formula 2 below and having a softening point of 99° C., a molecular weight of 787, and a viscosity of 390 cps at 150° C. was synthesized (dual-stage process).

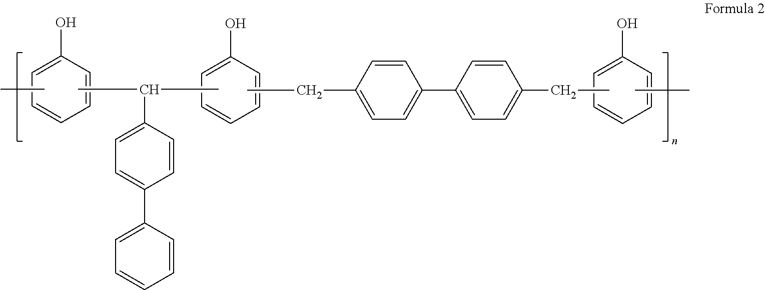

In Formula 2, n is a natural number of 1 to 100

### Example 2

### Preparation of Novolac Epoxy Resin

600 g of the resin of Formula 2 and 949.6 g of epichlorohydrin were added to a flask equipped with a stirrer and a cooling device. The mixture was dissolved and reacted while dropwise adding 150 g of a 50% aqueous NaOH solution, as a catalyst, thereto for 4 hours, and then residual epichlorohydrin was collected. 750 g of methyl isobutyl ketone and 264 g of PPW were added to the synthesized resin to perform separation and washing, thereby removing a salt produced thereby. Then, residual solvent was collected to synthesize a resin represented by Formula 3 below having an equivalent weight of 270.1 g/eq, a chlorine content of 280 ppm, and a softening point of 60.7° C. (B&R).

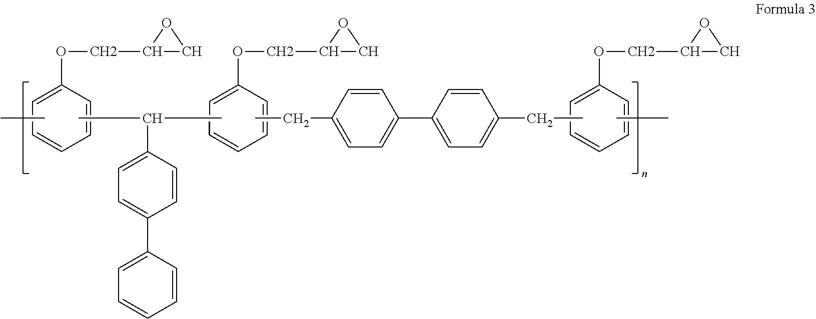

In Formula 3, n is a natural number of 1 to 100.

### Example 3

### Preparation of Novolac Epoxy Resin Composition

100 g of the resin of Formula 3 prepared in Example 2, as an epoxy resin, 64.79 g of Xylok resin, as a hardener, 1.5 g of triphenylphosphine, as a catalyst, and 1210 g of silica, as a filler, were mixed to prepare an epoxy resin composition.

### Example 4

### Preparation of Novolac Resin Using Benzaldehyde

182 g of benzaldehyde, 470 g of phenol, 231 g of 4,4′-bis(methoxy-methyl biphenyl) (BMMB), and 47 g of purified process water (PPW) were added to a flask equipped with a stirrer and a cooling device, and the mixture was dissolved while raising temperature to 90° C. 1.41 g of p-toluene sulfonic acid monohydrate (PTSA) was added thereto as a catalyst, and the mixture was maintained under the same conditions for 3 hours. The mixture was dehydrated by heating to 115° C., and the phenol was collected by adjusting temperature and pressure to 190° C. and 5 torr. Then, 20 g of PPW was added dropwise thereto to minimize residual phenol. As a result, a resin represented by Formula 4 below and having a softening point of 92° C., a molecular weight of 859, and a viscosity of 67 cps at 150 t was synthesized (single-stage process).

182 g of benzaldehyde, 470 g of phenol, and 47 g of purified process water (PPW) were added to a flask equipped with a stirrer and a cooling device, and the mixture was dissolved while raising temperature to 90° C., 1.41 g of p-toluene sulfonic acid monohydrate (PTSA) was added thereto as a catalyst, and the mixture was maintained under the same conditions for 1 hour. Then, 231 g of 4,4′-bis(methoxy-methyl biphenyl) (BMMB), as a second raw material, was added thereto, and the mixture was maintained under the same conditions for 3 hours. The mixture was dehydrated by heating to 115° C., and the phenol was collected by adjusting temperature and pressure to 190° C. and 5 torr. Then, 20 g of PPW was added dropwise thereto to minimize residual phenol. As a result, a resin represented by Formula 4 below and having a softening point of 92° C., a molecular weight of 859, and a viscosity of 67 cps at 150° C. was synthesized (dual-stage process).

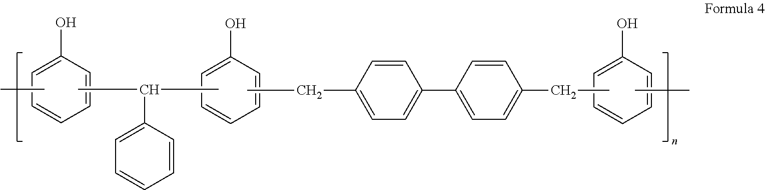

In Formula 4, n is a natural number of 1 to 100.

### Example 5

### Preparation of Novolac Epoxy Resin

208 g of the resin of Formula 4 and 412 g of epichlorohydrin were added to a flask equipped with a stirrer and a cooling device. The mixture was dissolved and reacted while dropwise adding 80 g of a 50% aqueous NaOH solution, as a catalyst, thereto for 4 hours, and then residual epichlorohydrin was collected, 528 g of methyl isobutyl ketone and 264 g of PPW were added to the synthesized resin to perform separation and washing, thereby removing a salt produced thereby. Then, residual solvent was collected to synthesize a resin represented by Formula 5 below having an equivalent weight of 237.8 g/eq, a chlorine content of 87 ppm, and a softening point of 60° C. (B&R).

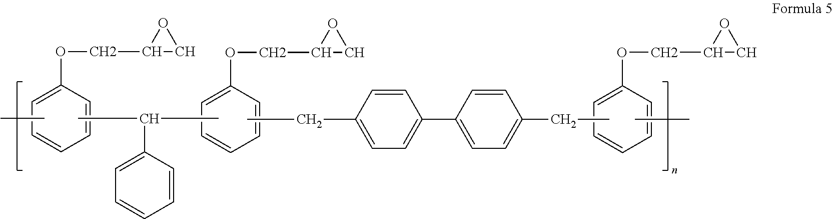

In Formula 5, n is a natural number of 1 to 100.

### Example 6

### Preparation of Novolac Epoxy Resin Composition

100 g of the resin of Formula 5 prepared in Example 5, as an epoxy resin, 73.6 g of Xylok resin, as a hardener, 1.5 g of triphenylphosphine, as a catalyst, and 1283 g of silica, as a filler, were mixed to prepare an epoxy resin composition.

### Comparative Example 1

An epoxy resin composition was prepared in the same manner as in Example 3, except that NC-3000 produced by Nippon Kayaku Co., Ltd., and commercially available as a self-extinguishing epoxy resin, was used.

### Comparative Example 2

An epoxy resin composition was prepared in the same manner as in Example 3, except that YDCN-500-4P, which is not a self-extinguishing epoxy resin but a generally use o-cresol novolac epoxy resin produced by Kukdo Chemical Co., Ltd., was used.

General properties of epoxy resins prepared according to the present invention using a dual-stage process and prepared in Comparative examples 1 and 2 are shown in Table 1 below.

TABLE 1
Properties of the epoxy resins prepared in Example 2 and
Example 5 and the epoxy resins prepared in Comparative
Example 1 and Comparative Example 2

| | | | Epoxy | Epoxy |
|---|---|---|---|---|
| | Epoxy | Epoxy | resin of | resin of |
| | resin of | resin of | Comparative | Comparative |
| | Example 2 | Example 5 | Example 1 | Example 2 |
| Equivalent | 270.1 | 237.8 | 276.7 | 203.3 |
| weight of | | | | |
| epoxy (g/eq) | | | | |
| Hydrolysable Cl | 85 | 82 | 50 | 80 |
| (ppm) | | | | |
| Softening point | 60.7 | 57.8 | 55.2 | 62.4 |
| (° C.) | | | | |

Components and contents of the epoxy resin compositions are shown in Table 2.

TABLE 2
Components and contents of EMC composition

| | | | Comparative | Comparative |
|---|---|---|---|---|
| | Example 3 | Example 6 | Example 1 | Example 2 |
| | (content: g) | (content: g) | (content: g) | (content: g) |
| Epoxy | Epoxy | Epoxy | NC-3000 | YDCN-500-4P |
| resin | resin of | resin of | (100) | (100) |
| | Example 2 | Example 5 | | |
| | (100) | (100) | | |
| Hardener | Xylok (64.8) | Xylok (73.6) | Xylok (63.3) | Xylok (86.1) |
| Catalyst | Triphenyl | Triphenyl | Triphenyl | Triphenyl |
| | phosphine | phosphine (1.5) | phosphine | phosphine (1.5) |
| | (1.5) | | (1.5) | |
| Filler | Silica (1210) | Silica (1283) | Silica (1197) | Silica (1364) |

Gel Time

Gel time was measured in order to evaluate reactivity of the epoxy resin compositions.

A dry resin was powdered, and 1 g of the powered sample was placed on a hot plate at 175° C. Then, the sample was stirred with a toothpick and pulled upward with the toothpick. A time period was measured until the resin was not pulled in a thread-like form.

Flame Retardancy

Flame retardancy of the epoxy resin compositions was measured using a vertical combustion test in accordance with UL-94 regulations. A sample was exposed to flame and burned for 10 seconds. When the sample self-extinguished within 10 seconds after the cause of the fire was removed, a UL V-0 rating was achieved.

Shrinkage

A mold and a sample were prepared, and shrinkage of the EMC was measured according to a shrinkage measurement method by measuring length of the mold and the sample using calipers.

Heat Resistance

The epoxy resin compositions were maintained at 90° C. for 2 hours and at 150° C. for 4 hours to harden the epoxy resin compositions. Then, glass transition temperatures (Tg) of the epoxy resin compositions were measured through DSC analysis.

Flexural Strength and Flexural Modulus

A width and a thickness of a sample were measured using a micrometer in accordance with guidelines of a universal testing machine (UTM).

Results are shown in Table 3 below.

TABLE 3

| | | Raw materials | | | |
|---|---|---|---|---|---|
| | | | | Comparative | Comparative |
| Component | | Example 3 | Example 6 | Example 1 | Example 2 |
| Epoxy Resin | | Epoxy resin | Epoxy resin | NC-3000 | YDCN-500-4P |
| | | of Example | of Example | | |
| | | 2 | 5 | | |
| Hardener | | Xylok | | | |
| Catalyst (Tri phenyl | | 0.24% | 0.24% | 0.24% | 0.24% |
| phosphine) | | | | | |
| Filler (Silica) | | 88% | 88% | 88% | 88% |
| Gel Time (175 C.) | | 29 sec | 26 sec | 34 sec | 25 sec |
| UL-94 | | 6 sec | 7 sec | 10 sec | Burn |
| Shrinkage | Non-Post Cure | 0.24% | 0.25% | 0.27% | 0.33% |
| | Post Mold Cure | 0.25% | 0.25% | 0.27% | 0.33% |
| TMA | Tg | 145 | 139 | 128 | 140 |
| Flexural | RT@260° C. | 150.9 | 151.1 | 161.0 | 161.3 |
| strength | | | | | |
| (Kg/mm²) | | | | | |
| Flexural | RT@260° C. | 240067 | 240082 | 232077 | 2180124 |
| modulus | | | | | |
| (Kg/mm²) | | | | | |

As shown in Table 3, by use of the epoxy resin according to the present invention, an EMC having excellent flame retardancy, high dimensional stability, and excellent physical property balance may be prepared without using a halogen flame retardant, a phosphorous flame retardant, or the like.

When the epoxy resin according to the present invention is used in an EMC composition, flame retardancy was improved to a V-Q rating. Thus, it was confirmed that excellent flame retardancy was obtained without using a halogen flame retardant or a phosphorous flame retardant. It was confirmed that the epoxy resin according to the present invention has flame retardancy and other physical property balance better than or similar to commercially available conventional NC-3000 manufactured by Nippon Kayaku Co., Ltd.

The epoxy resin according to the present invention has excellent dimensional stability due to low shrinkage. The epoxy resin according to the present invention has a lower shrinkage than commercially available NC-3000.

In general, as Tg increases, modulus tends to increase. The epoxy resin according to the present invention (Examples 2 and 5) has higher Tg and similar or lower flexural modulus upon comparison with commercially available NC-3000 (Comparative Example 1). These properties may provide ideal physical property balance to physical properties of the EMC.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An epoxy resin represented by Formula 1 below: 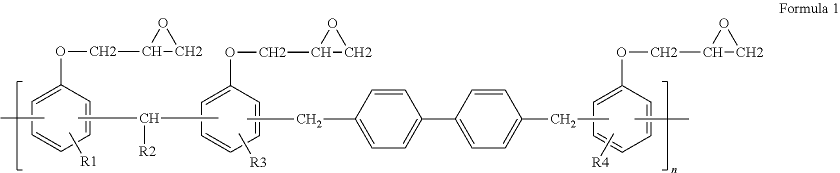
wherein R1, R3, and R4 are each independently H, CH₃, or an alkyl group,
R2 is a biphenyl group 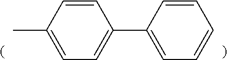
or a benzyl group 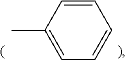
and
n is a natural number of 1 to 100.

2. A method of preparing an epoxy resin represented by Formula 3 below, the method comprising:
(1) synthesizing a resin represented by Formula 2 below by adding 212 g of 4-phenylbenzaldehyde, 550 g of phenol, 242 g of 4,4′-bis(methoxy-methyl biphenyl) (BMMB), and 58 g of purified process water (PPW) to a flask equipped with a stirrer and a cooling device, dissolving the mixture while raising temperature to 90° C., adding 1.41 g of p-toluene sulfonic acid monohydrate (PTSA), as a catalyst, to the flask, maintaining the flask under the same conditions for 3 hours, dehydrating the mixture by heating to 115° C., collecting the phenol by adjusting temperature and pressure to 190° C. and 5 torr, and adding dropwise 20 g of PPW to the mixture to reduce residual phenol, or
synthesizing a resin represented by Formula 2 below by adding 212 g of 4-phenylbenzaldehyde, 550 g of phenol, and 58 g of purified process water (PPW) to a flask equipped with a stirrer and a cooling device, dissolving the mixture while raising temperature to 90° C., adding 1.41 g of p-toluene sulfonic acid monohydrate (PTSA), as a catalyst, to the flask, maintaining the flask under the same conditions for 1 hour, adding 242 g of 4,4′-bis(methoxy-methyl biphenyl) (BMMB), as a second raw material, to the flask, maintaining under the same conditions for 3 hours, dehydrating the mixture by heating to 115° C., collecting the phenol by adjusting temperature and pressure to 190° C. and 5 torr, and adding dropwise 20 g of PPW to the mixture to reduce residual phenol, 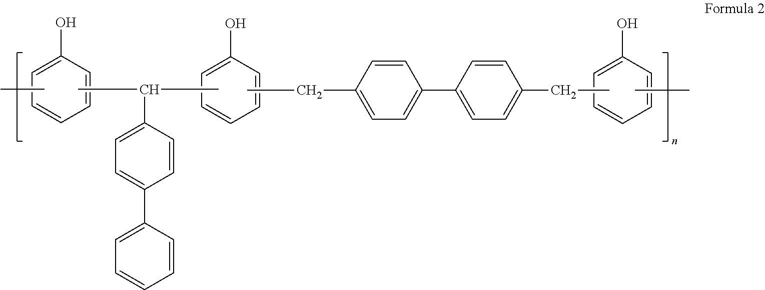
wherein n is a natural number of 1 to 100; and
(2) preparing an epoxy resin represented by Formula 3 below by adding 600 g of the resin represented by Formula 2 and 949.6 g of epichlorohydrin to a flask equipped with a stirrer and a cooling device, dissolving the mixture and performing reaction while adding dropwise 150 g of a 50% aqueous NaOH solution, as a catalyst, to the flask for 4 hours, collecting residual epichlorohydrin, adding 750 g of methyl isobutyl ketone and 264 g of PPW to the synthesized resin to perform separation and washing, thereby removing a produced salt, and collecting residual solvent: 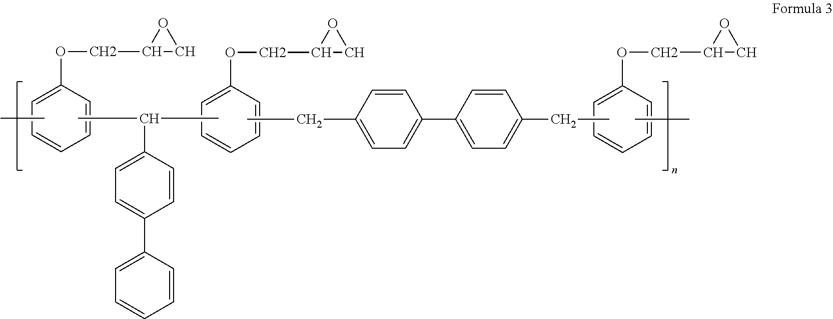
wherein n is a natural number of 1 to 100.

3. A method of synthesizing an epoxy resin represented by Formula 5 below, the method comprising:
(1) synthesizing a resin represented by Formula 4 below by adding 182 g of benzaldehyde, 470 g of phenol, 231 g of 4,4′-bis(methoxy-methyl biphenyl) (BMMB), and 47 g of purified process water (PPW) to a flask equipped with a stirrer and a cooling device, dissolving the mixture while raising temperature to 90° C., adding 1.41 g of p-toluene sulfonic acid monohydrate (PTSA), as a catalyst, to the flask, maintaining the flask under the same conditions for 3 hours, dehydrating the mixture by heating to 115° C., collecting the phenol by adjusting temperature and pressure to 190° C. and 5 torr, and adding dropwise 20 g of PPW to the mixture to reduce residual phenol, or
synthesizing a resin represented by Formula 4 below by adding 182 g of benzaldehyde, 470 g of phenol, and 47 g of purified process water (PPW) to a flask equipped with a stirrer and a cooling device, dissolving the mixture while raising temperature to 90° C., adding 1.41 g of p-toluene sulfonic acid monohydrate (PTSA), as a catalyst, to the flask, maintaining the flask under the same conditions for 1 hour, adding 231 g of 4,4′-bis(methoxy-methyl biphenyl) (BMMB), as a second raw material, to the flask, maintaining under the same conditions for 3 hours, dehydrating the mixture by heating to 115° C., collecting the phenol by adjusting temperature and pressure to 190° C. and 5 torr, and adding dropwise 20 g of PPW to the mixture to reduce residual phenol, 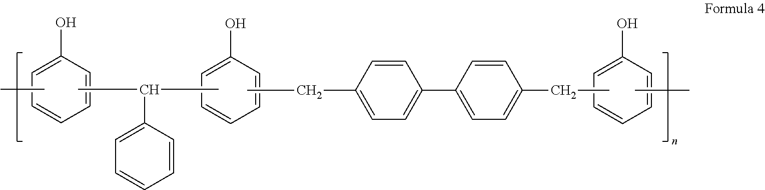
wherein n is a natural number of 1 to 100; and
(2) preparing an epoxy resin represented by Formula 5 below by adding 208 g of the resin represented by Formula 4 and 412 g of epichlorohydrin to a flask equipped with a stirrer and a cooling device, dissolving the mixture and performing a reaction while adding dropwise 80 g of a 50% aqueous NaOH solution, as a catalyst, to the flask for 4 hours, collecting residual epichlorohydrin, adding 528 g of methyl isobutyl ketone and 264 g of PPW to the synthesized resin to perform separation and washing, thereby removing a produced salt, and collecting residual solvent: 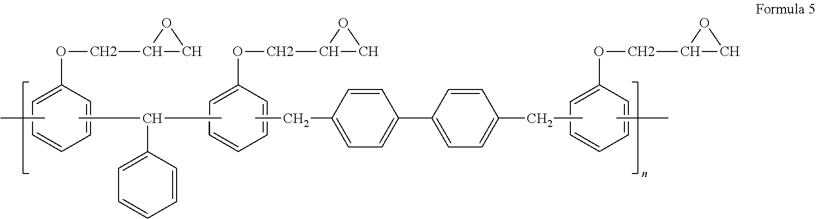
wherein n is a natural number of 1 to 100.

4. An epoxy resin composition for an epoxy molding compound prepared by mixing one of the epoxy resins prepared according to the method of claim 2, a hardener, a catalyst, and a filler.

5. An epoxy resin composition for an epoxy molding compound prepared by mixing one of the epoxy resins prepared according to the method of claim 3, a hardener, a catalyst, and a filler.
